(19) United States
(12) Patent Application Publication
(10) Pub. No.: US 2025/0156217 A1
(43) Pub. Date: May 15, 2025

(54) MID-PROCESS RECONFIGURATION

(71) Applicant: INTERNATIONAL BUSINESS MACHINES CORPORATION, ARMONK, NY (US)

(72) Inventors: Zachary A. Silverstein, Georgetown, TX (US); Jeremy R. Fox, Georgetown, TX (US); Logan Bailey, Atlanta, GA (US)

(21) Appl. No.: 18/508,473

(22) Filed: Nov. 14, 2023

(51) Int. Cl. G06F 9/48; G06N 3/006

(52) U.S. Cl. CPC G06F 9/485; G06N 3/006

(57) ABSTRACT

Described is a method for managing modification requests and performing a mid-process reconfiguration based on the modification requests includes receiving a request during a process stream and determining the request is indicative of a reversal of progress of the process stream or indicative of a data change being utilized for the process stream. The method also includes analyzing a context for the reversal of progress of the process stream or the data change being utilized for the process stream. In response to determining a modification is required to at least one workflow step from a plurality of workflow steps of the process stream based on the analyzing of the context, the method also includes determining the modification performable on the at least one workflow step from the process stream. The method also includes performing the modification on the at least one workflow step from the process stream.

### BACKGROUND

This disclosure relates generally to process generation utilizing artificial intelligence, and in particular to mid-process reconfiguration utilizing artificial intelligence based on user requests.

Presently, enterprises have moved towards facilitation of event driven architectures and ad-hoc process generation utilizing artificial intelligence (AI). Often processes may need to be halted prior to completion and either resumed or restarted based on changes to variables and reconfiguration options introduced with various requests by a user. An example of process generation utilizing AI can include an enterprise utilizing a software system to automate inventory management operations, where the enterprise may need to update new inventory tracking and ordering procedures. Such updates can include adding new features, updating database schema, or modifying the system's processing logic ad-hoc mid-process to avoid down time.

### SUMMARY

Embodiments in accordance with the present invention disclose a method, computer program product and computer system for mid-process reconfiguration, the method, computer program product and computer system can receive a request during a process stream. The method, computer program product and computer system can determine the request is indicative of a reversal of progress of the process stream or indicative of a data change being utilized for the process stream. The method, computer program product and computer system can analyze a context for the reversal of progress of the process stream or the data change being utilized for the process stream. the method, computer program product and computer system can, responsive to determining a modification is required to at least one workflow step from a plurality of workflow steps of the process stream based on the analyzing of the context, determine the modification performable on the at least one workflow step from the process stream. The method, computer program product and computer system can perform the modification on the at least one workflow step from the process stream.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a process flow for managing modification requests and performing a mid-process reconfiguration based on the modification requests, in accordance with an embodiment of the present invention.

FIG. 3 depicts a flowchart of a mid-process reconfiguration program for performing modifications during a process stream, in accordance with an embodiment of the present invention.

FIG. 4A illustrates an example of a mid-process reconfiguration program initiating a process stream, in accordance with an embodiment of the present invention.

FIG. 4B illustrates an example of a mid-process reconfiguration program receiving a request during a process stream indicative of reversal of progress, in accordance with an embodiment of the present invention.

FIG. 4C illustrates an example of a mid-process reconfiguration program determining a modification and performing the modification that includes a reversal of progress, in accordance with an embodiment of the present invention.

FIG. 4D illustrates an example of a mid-process reconfiguration program resuming a process stream along a new branch subsequent to a reversal of progress of an old branch, in accordance with an embodiment of the present invention.

### DETAILED DESCRIPTION

According to an aspect of the invention, there is provided a computer-implemented method, a computer program product, and a computer system that includes receiving a request during a process stream. The computer-implemented method, the computer program product, and the computer system further includes determining the request is indicative of a reversal of progress of the process stream or indicative of a data change being utilized for the process stream. The computer-implemented method, the computer program product, and the computer system further includes analyzing a context for the reversal of progress of the process stream or the data change being utilized for the process stream. The computer-implemented method, the computer program product, and the computer system further includes in response to determining a modification is required to at least one workflow step from a plurality of workflow steps of the process stream based on the analyzing of the context, determining the modification performable on the at least one workflow step from the process stream. The computer-implemented method, the computer program product, and the computer system further includes performing the modification on the at least one workflow step from the process stream. A technical advantage includes performing a mid-process reconfiguration during a process stream to prevent the re-initialization of the process stream from a starting point when receiving a request. With the mid-process reconfiguration via performing of the modification on the workflow step, the process stream can continue without interruption. As a result of the mid-process reconfiguration, down time of the process stream is reduced, and time is saved due to not having to initialize the process stream from the starting when receiving the request.

In embodiments, the computer-implemented method, the computer program product, and the computer system can optionally include initializing the process stream based on a trigger event, where the process stream includes the plurality of workflow steps performable across a plurality of applications. A technical advantage includes utilizing a trigger event for the mid-process reconfiguration, eliminating the need for user intervention in the process stream to identify a point where a modification is required during the process stream. As a result of the trigger event, down time of the process stream is reduced.

In embodiments, the computer-implemented method, the computer program product, and the computer system includes initializing the process stream based on a trigger event, where the process stream includes the plurality of workflow steps performable across a plurality of applications. For performing the modification on the at least one workflow step from the process stream, the computer-implemented method, the computer program product, and the computer system can optionally include reversing from a current workflow step to a previous workflow step in the process stream, where the previous workflow step is the at least one workflow step from the process stream where the modification is required. The computer-implemented method, the computer program product, and the computer system can optionally include storing data associated with the process stream between the current workflow step and the previous workflow step. The computer-implemented method, the computer program product, and the computer system can optionally include re-initializing a new process stream from the previous workflow step based on the request. A technical advantage includes performing a mid-process reconfiguration during a process stream to prevent the re-initialization of the process stream from a starting point when receiving a request. With the mid-process reconfiguration via performing of the modification on the workflow step, a portion of the process stream can be reverse, and the process stream re-initialized from the reversed portion of the process stream. As a result of the reversed portion of the process stream, the process stream no longer re-initialized from the starting point when receiving the request resulting in time being saved during the workflow.

In embodiments, the computer-implemented method, the computer program product, and the computer system includes initializing the process stream based on a trigger event, where the process stream includes the plurality of workflow steps performable across a plurality of applications. For performing the modification on the at least one workflow step from the process stream, the computer-implemented method, the computer program product, and the computer system can optionally include reversing from a current workflow step to a first workflow step from the plurality of workflow steps in the process stream based on the data change being utilized for the process stream. The computer-implemented method, the computer program product, and the computer system can optionally include re-initializing a new process stream from the first workflow step from the plurality of workflow steps based on the request. A technical advantage includes performing a mid-process reconfiguration during a process stream to prevent the process stream from continuing to perform a workflow with old or incorrect data. With the mid-process reconfiguration via performing of the modification on the workflow step, the process stream can be stopped prior to completion and initialized from a starting step based on new data in the request. As a result of the re-initialization from the starting workflow step based on the new data in the request, the process stream with the old or incorrect data is stopped.

In embodiments, the computer-implemented method, the computer program product, and the computer system includes initializing the process stream based on a trigger event, where the process stream includes the plurality of workflow steps performable across a plurality of applications. For performing the modification on the at least one workflow step from the process stream, the computer-implemented method, the computer program product, and the computer system can optionally include altering a future workflow step from the plurality of workflow steps in the process stream, where the future workflow step is the at least one workflow step from the process stream where the modification is required. The computer-implemented method, the computer program product, and the computer system can optionally include initializing a new process stream from the future workflow step from the plurality of workflow steps based on the request. A technical advantage includes performing a mid-process reconfiguration during a process stream to prevent the re-initialization of the process stream from a starting point when receiving a request. With the mid-process reconfiguration via performing of the modification on the future workflow step, the process stream can remain active. As a result of the modification to the future workflow step, down time of the process stream is completely eliminated.

In embodiments, the computer-implemented method, the computer program product, and the computer system can optionally include receiving the request during the process stream via an AI chatbot component. A technical advantage includes an artificial intelligence-based user interface through which a user can provide a request to perform a mid-process reconfiguration of a process stream to ensure a modification can be performed to the process stream in an accelerated manner.

In embodiments, the computer-implemented method, the computer program product, and the computer system includes receiving the request during the process stream via an AI chatbot component The computer-implemented method, the computer program product, and the computer system can optionally include training, the AI chatbot component, via one or more user inputs to reverse or discard one or more workflow steps from the process stream based on the request, where the one or more user inputs flag, a start point or a stop point for the at least one workflow step in the process stream, or code script in the process stream. A technical advantage includes in training the artificial intelligence-based user interface through which a user can provide a request to perform a mid-process reconfiguration of a process stream to ensure a modification can be performed to the process stream in an accelerated manner. Through the training, the resulting artificial intelligence-based user interface can process requests from the user more accurately and perform the modifications to the process stream in a further accelerated manner.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

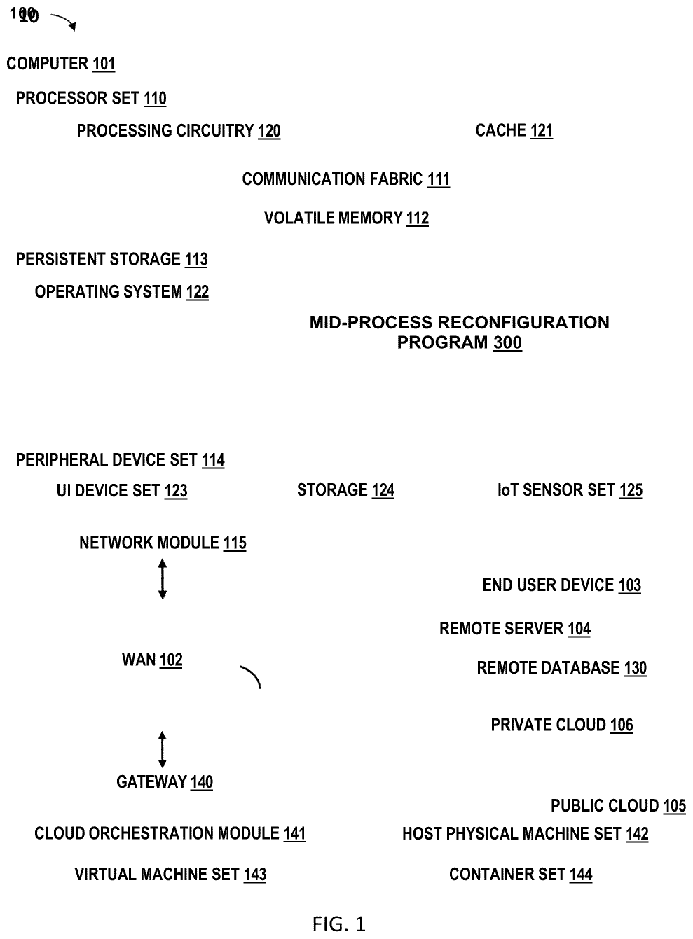

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as, mid-process reconfiguration program 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 300 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present invention provide a reconfiguration of an artificial intelligence (AI) generated process for instances where business requirements, environmental changes, and/or a system encounters unexpected events or errors. Embodiments of the present invention can be embedded in a chatbot automation action that supports ad-hoc interruption and reversion based on the progress of the automation (i.e., a workflow steps of a process). Additional, reconfiguration of a portion of the automation can occur based on changing variable related to the automation. Additional embodiments of the present invention can ingest an upper and a lower limit for one or more types of quality parameters that persist for the model and a specific subject matter or use case being covered by the automation.

Embodiments of the present invention allow for a user to opt-in to a mid-process reconfiguration program, where the user interfaces with the mid-process reconfiguration program that is integrated within an AI system. The mid-process reconfiguration program facilitates an event-driven workflow system that supports dynamic reconfiguration and AI integration by incorporating a machine learning model for AI-assisted process execution and integrate it into the workflow system. The mid-process reconfiguration program can be manually trained to reverse and/or discard one or more portions of the workflow steps of the process stream as executed by the payload. This is recognized by certain workflow steps in the process stream or code scripts of the execution that the user has flagged as start or stop points. The mid-process reconfiguration program can be automatically trained through a recurrent neural network (RNN) or convolutional neural networks (CNN) to reverse and/or discard one or more portions of the workflow steps of the process stream when payloads are used to execute application program interface (API) calls, database create, read, update, and delete (CRUD) actions or similar actions. The mid-process reconfiguration program facilitates ad-hoc generation of event-driven messaging and API integrations with other applications involved in the process stream, such as data storage and external services.

As the users interacts with AI interface through the chatbot interface, the AI model of the mid-process reconfiguration program utilizes natural language inference to define data objects and schemas for the process context and integrate them into a pre-existing or ad hoc generated workflow system. The mid-process reconfiguration program gathers information for data slots such as through natural language interaction. A machine learning (ML) component of the mid-process reconfiguration program monitors the workflow process and detects changes to the process context data object that may be generated via AI/human interaction or human override. As the user speaks a change that is indicative of modifying the business data, the mid-process reconfiguration program detects the modification and the mid-process reconfiguration program analyzes the new context and determines whether any prior activities need to be modified based on the new data. For example, the mid-process reconfiguration program determines how far along the process is currently through the flow and what is the specific change requested by the user. If the mid-process reconfiguration program determines modifications are necessary, the AI component of the mid-process reconfiguration program makes the necessary alterations to prior activities using the workflow system's dynamic reconfiguration capabilities. In some embodiment, the mid-process reconfiguration program can change the business data embedded in the flow. If a CRUD or API call has been executed, the mid-process reconfiguration program can pause or stop the current step and delete inflight data and restart it with improved data. The workflow system resumes execution from the modified activity and continues the process stream as normal.

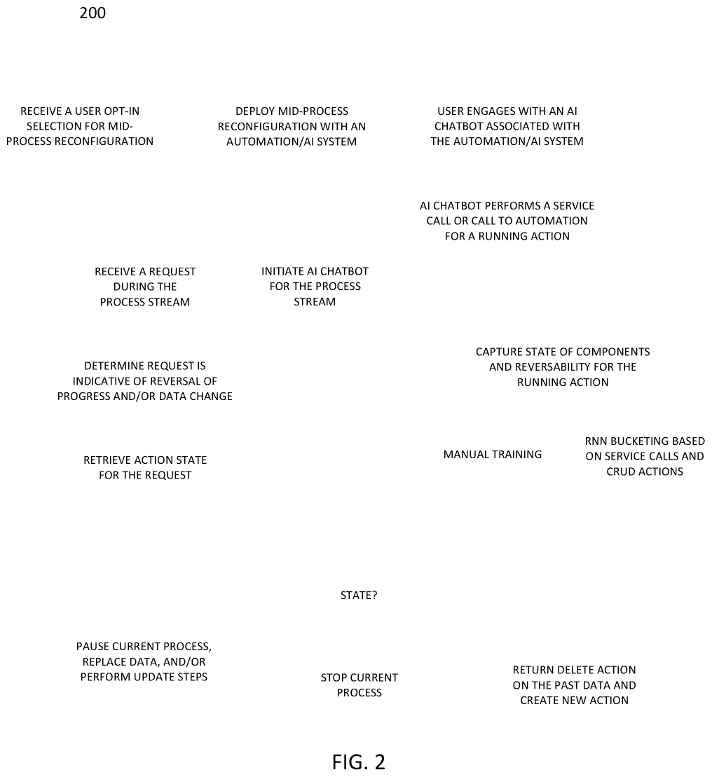

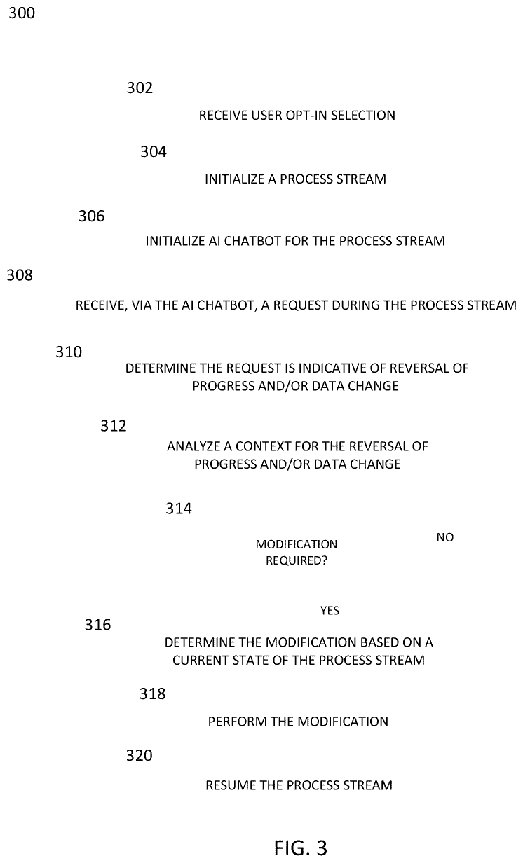

FIG. 2 depicts a process flow for managing modification requests and performing a mid-process reconfiguration based on the modification requests, in accordance with an embodiment of the present invention. Process flow 200 is an example of one embodiment of managing requests and performing a mid-process reconfiguration based on the modification requests that includes steps performed by mid-process reconfiguration program 300, discussed in further detail with regards to FIG. 3. Process flow 200 includes mid-process reconfiguration program 300 receiving a user opt-in selection for mid-process reconfiguration, where a user can provide a request to alter the process stream based on business requirements. In one example, mid-process reconfiguration program 300 is a component of an AI system with which a user interacts, where the user can enable or disable one or more features of mid-process reconfiguration program 300. In another example, mid-process reconfiguration program 300 is component of a software automation tool (e.g., inventory tracking software), where a user can enable or disable one or more features of mid-process reconfiguration program 300. Process flow 200 further includes mid-process reconfiguration program 300 deploying the mid-process reconfiguration with a software automation tool and/or AI system, where the user engages with an AI chatbot associated with the software automation tool and/or AI system.

Process flow 200 further includes mid-process reconfiguration program 300 performing, via the AI chatbot, a service call or call to automation for a running action of the process. However, process flow 200 also requires the training of mid-process reconfiguration program 300 by capturing a state of components and reversibility for the running action of the process. Mid-process reconfiguration program 300 can utilize manual training and/or recurrent neural network (RNN) bucketing based on server calls and create, read, update and delete (CRUD) actions for the process. Mid-process reconfiguration program 300 is manually trained (i.e., with user input) to remove and/or reverse different portions of workflow steps in the process as performed by the payload, where a user has flagged (i.e., inputs) start or stop points via certain workflow steps or scripts in the process. Mid-process reconfiguration program 300 is further trained through RNN bucketing or convolutional neural networks (CNN) to remove and/or reverse different portions of workflow steps in the process when payloads are utilized to perform application program interface (API) calls, database CRUD action, and or similar action items during the workflow steps in the process.

Process flow 200 further includes mid-process reconfiguration program 300 initiating the AI chatbot for the process stream, where the user can interact and provide requests via the AI chatbot to perform a mid-process modification to the process stream. Mid-process reconfiguration program 300 facilitates the ad-hoc generation of event-driven messaging and API integrations with one or more other applications involved in the workflow steps in the process, such as, data storage and external services. Process flow 200 further includes mid-process reconfiguration program 300 receiving a request, via the AI chatbot, from a user during the process stream and determining the request is indicative of reversal of progress and/or data change. A request that is indicative of reversal of progress represents a request where a portion of previously performed workflow steps in the process have to be removed and/or reversed. A request that is indicative of data change represents a request with new data that can alter a yet to be performed (i.e., future) workflow step in the process.

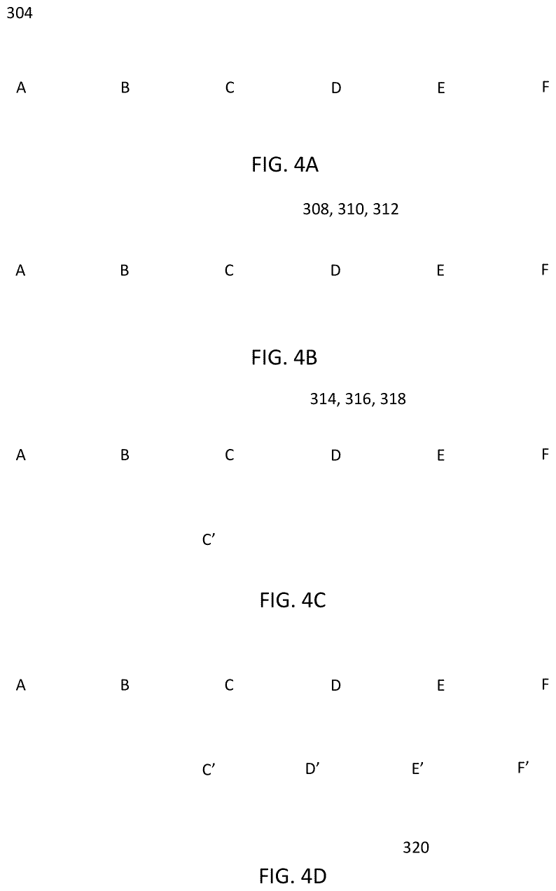

Process flow 200 further includes mid-process reconfiguration program 300 retrieving an action state for the request and determining whether a modification is required based on the retrieve action state. If mid-process reconfiguration program 300 determines the process is updateable, mid-process reconfiguration program 300 performs the modification of pausing the current process, replacing the data, and/or performing the update steps. If mid-process reconfiguration program 300 determines the process is not updateable, mid-process reconfiguration program 300 stops the current process and returns a delete action on all the past data and creates a new action, where the process re-initializes from the start. If mid-process reconfiguration program 300 determines the process is updateable but the action has occurred, mid-process reconfiguration program 300 returns a delete action on a portion of the past data and creates a new action, where the process re-initializes from the point of the delete action. An example of this modification is described in further detail with regards to FIGS. 4A through 4D.

FIG. 3 depicts a flowchart of a mid-process reconfiguration program for performing modifications during a process stream, in accordance with an embodiment of the present invention.

Mid-process reconfiguration program 300 receives a user opt-in selection (302). For mid-process reconfiguration program 300 to provide a user the ability to request an alteration via a modification during a process stream, mid-process reconfiguration program 300 receives the user opt-in selection via a user profile setting. In one embodiment, mid-process reconfiguration program 300 is a component of an AI system with which a user interacts, where the user can enable or disable one or more features of mid-process reconfiguration program 300. The enabling or disabling of the one or more features of mid-process reconfiguration program 300 represents the user providing an opt-in or an opt-out selection for the one or more features described herein. For example, a feature can include a type of modification that mid-process reconfiguration program 300 can perform depending on a request received from the user. The user can opt-in for one feature (e.g., workflow step reversal in the process stream) and opt-out for another feature (e.g., restart workflow steps from the beginning for the process stream). In another example, mid-process reconfiguration program 300 is component of a software automation tool (e.g., inventory tracking software), where a user can enable or disable one or more features of mid-process reconfiguration program 300. Similar to the example described above, the enabling or disabling of the one or more features of mid-process reconfiguration program 300 represents the user providing an opt-in or an opt-out selection for the one or more features described herein.

Mid-process reconfiguration program 300 initializes a process stream (304). Mid-process reconfiguration program 300 initiates the process stream by performing each of the workflow steps previously established for the process stream. The workflow process can include the integration of multiple applications, where actions performed by each of the multiple application comprises the process stream. Mid-process reconfiguration program 300 can initiate the process stream via an event trigger. In one example, user A is a product manager for an online retailer, where user A is tasked with creating a workflow process for the online retailer's order fulfillment system. User A develops an AI-generated process for purchase and shipping management for the online retailer. Mid-process reconfiguration program 300 initiates the process stream upon receiving an order (i.e., event trigger) for the online retailer, which subsequently resulting the workflow steps of the process being performed across multiple applications. The multiple applications can include inventory tracking systems, payment handling systems, shipment management systems, data storage systems, and any other system required to handle the event trigger for mid-process reconfiguration program 300.

Mid-process reconfiguration program 300 initializes an AI chatbot for the process stream (306). Mid-process reconfiguration program 300 incorporates a machine learning (ML) model for AI-assisted process execution and integrates into the workflow steps of the process stream. Prior to initiating the AI chatbot component of mid-process reconfiguration program 300 for the process stream, the AI chatbot component of mid-process reconfiguration program 300 can be trained a user to reverse and/or discard one or more portions of the workflow steps of the process stream. The user can flag start or stop points for certain workflow steps in the process stream or code scripts of the process stream. The AI chatbot component of mid-process reconfiguration program 300 can also be automatically trained through RNN or CNN to reverse and/or discard one or more portions of the workflow steps of the process stream when payloads are utilized to execute API calls, database CRUD action, or similar actions. Mid-process reconfiguration program 300 initiates the AI chatbot component for the process stream, where the AI chatbot component facilities ad-hoc generation of event drive messaging and API integration with one or more other applications involved in the process stream (inventory tracking systems, data storage systems etc.).

Mid-process reconfiguration program 300 receives, via the AI chatbot, a request during the process stream (308). In one embodiment, mid-process reconfiguration program 300 is performing the workflow steps of the process stream and mid-process reconfiguration program 300 receives, via the AI chatbot component, a request during the process stream. In another embodiment, one or more applications are performing the workflow steps of the process stream and mid-process reconfiguration program 300 receives, via the AI chatbot component, a request during the process stream. The AI chatbot component of mid-process reconfiguration program 300 can receive the request via a text input from a user and/or an audible input from a user.

Mid-process reconfiguration program 300 determines the request is indicative of reversal of progress and/or data change (310). Mid-process reconfiguration program 300 determines the request is indicative of a reversal of progress of the process stream when one or more workflow steps in the process stream have to be reversed and/or discard. Mid-process reconfiguration program 300 determines the request is indicative of a data change when one or more data variable inputs for at least one of the workflow steps can affect a result of the process stream. Mid-process reconfiguration program 300 can utilize natural language processing for the request received via the AI chatbot to define data objects and schemas for a context of the process stream and integrates the defined data objects and schemas into the workflow steps of the process stream. Mid-process reconfiguration program 300 can gather additional information for the data slots via the natural language interactions between the user and the AI chatbot component. From a previously discussed example, user A is a product manager for an online retailer, where user A is tasked with creating a workflow process for the online retailer's order fulfillment system. User A develops an AI-generated process for purchase and shipping management for the online retailer. Mid-process reconfiguration program 300 initiates the process stream upon receiving an order (i.e., event trigger) for the online retailer, which subsequently resulting the workflow steps of the process being performed across multiple applications. During the performing of the workflow steps, mid-process reconfiguration program 300 receives, via the AI chatbot, a request and determines the request is indicative of reversal of process and/or data changes, since mid-process reconfiguration program 300 determines the request includes an alteration to object data pertaining to customer preferences in a 7^{th} step of the workflow steps of the process stream.

Mid-process reconfiguration program 300 analyzes a context for the reversal of progress and/or data change (312). Mid-process reconfiguration program 300 monitors steps of the process stream and detects that the request, via the AI chatbot component (i.e., user override), for a change is to a data object of the context of the process stream, mid-process reconfiguration program 300 determines that the request include modifying business data for a portion of the workflow steps of the process stream. From a previously discussed example, user A is a product manager for an online retailer, where user A is tasked with creating a workflow process for the online retailer's order fulfillment system and develops an AI-generated process for purchase and shipping management for the online retailer. During the performing of the workflow steps, mid-process reconfiguration program 300 receives, via the AI chatbot, a request and determines the request is indicative of reversal of process and/or data changes, since mid-process reconfiguration program 300 determines the request includes an alteration to object data pertaining to customer preferences in a 7^{th} step of the workflow steps of the process stream. Mid-process reconfiguration program 300 analyzes the context for the reversal of the progress and/or data change and determines that a current workflow step of the process stream is currently the 8^{th} step. Therefore, mid-process reconfiguration program 300 determines a reversal of progress is required to at least the 7^{th} step of the workflow steps of the process stream based on the analyzing of the context. In another example, mid-process reconfiguration program 300 analyzes a context for the reversal of progress and/or data changes and determines an entire reversal of progress is required, where the current process stream needs to be discarded and the process stream re-initiated from a 1^{st} step from the workflow steps of new process stream. In yet another example, mid-process reconfiguration program 300 analyzes a context for the reversal of progress and/or data changes and determines a data change without reversal of the progress is possible, since the current 5^{th} step of the workflow steps of the process stream is prior to the alteration to object data pertaining to customer preferences in a 7^{th} step of the workflow steps of the process stream.

Mid-process reconfiguration program 300 determines whether modification is required to the process stream (decision 314). Mid-process reconfiguration program 300 determines how far along the current process stream is in the workflow steps and a specific change that is requested by the user to determine whether a modification is required to the workflow steps of the process stream. In the event mid-process reconfiguration program 300 determines a modification is required to the process stream (“yes” branch, decision 314), mid-process reconfiguration program 300 determines the modification based on a current state of the process stream (316). In the event mid-process reconfiguration program 300 determines a modification is not required to the process stream (“no” branch, decision 314), mid-process reconfiguration program 300 resumes the process stream (320).

Mid-process reconfiguration program 300 determines the modification based on a current state of the process stream (316). A current state of the process stream represents a progress in the workflow steps of the process stream. Mid-process reconfiguration program 300 determines the modification based on a current state of the process stream, where the current state of the process stream is provided from the analyzing of the context for the reversal of progress and/or data change. Where possible, mid-process reconfiguration program 300 determines modification to perform in the business data embedded in the process stream. However, if for example, a CRUD or an API call was performed in a workflow step of the process stream, mid-process reconfiguration program 300 determines a modification includes pausing the current process stream, deleting any inflight data associated with the performed workflow step, and re-initiating the process stream with the new data provided in the request by the user. From a previous example, mid-process reconfiguration program 300 determines the request includes an alteration to object data pertaining to customer preferences in a 7^{th} step of the workflow steps of the process stream. Mid-process reconfiguration program 300 analyzed the context for the reversal of the progress and/or data change and determines that a current workflow step of the process stream is currently the 8^{th} step (i.e., the current state of the process stream). Therefore, mid-process reconfiguration program 300 determines a modification is required that includes a reversal of progress to at least the 7^{th} step of the workflow steps of the process stream from the current state of the 9^{th} step of the workflow steps of the process stream, based on the analyzing of the context.

From another previous example, mid-process reconfiguration program 300 analyzed the context for the reversal of progress and/or data changes and determines an entire reversal of progress is required, where the current process stream needs to be discarded and the process stream re-initiated from a 1^{st} step from the workflow steps of new process stream. Even though the current state (i.e., 8^{th} step of the workflow steps) of the process stream indicates the process stream has not been completed, the request includes a data change that affects all previous performed steps of the workflow steps of the process stream. As a result, mid-process reconfiguration program 300 determines a modification is required that includes a reversal and a discarding of all previously performed workflow steps and re-initialization of a new process stream is required. From yet another previous example, mid-process reconfiguration program 300 analyzed a context for the reversal of progress and/or data changes and determines a data change without reversal of the progress is possible, since the current 5^{th} step of the workflow steps of the process stream is prior to the alteration to object data pertaining to customer preferences in a 7^{th} step of the workflow steps of the process stream. As a result, mid-process reconfiguration program 300 determines a modification is required that includes altering the workflow steps from a future step (i.e., the 7^{th} step) from the workflow steps and implementing a new process stream from the 7^{th} step onwards in the workflow steps.

Mid-process reconfiguration program 300 performs the modification (318). Mid-process reconfiguration program 300 performs the modification based on the determination in (316). In one embodiment, mid-process reconfiguration program 300 can display a summary of modifications to the workflow steps of the current process stream to the user and can query the user, via the AI chatbot module, for a confirmation to perform the modification being displayed to the user. Subsequent to confirmation from the user, mid-process reconfiguration program 300 performs the modification to the workflow steps of the process stream. Mid-process reconfiguration program 300 can also display one or more options in addition to the modifications to be performed. An example of the one or more options can include re-initiating the process stream from the beginning (i.e., 1^{st} step of the process stream) rather than a later process stream (e.g., 3^{rd} step of the process stream) or performing an original process stream to completion and performing a new process stream with the requested modification. Mid-process reconfiguration program 300 can store results for both the new process stream and the old process stream for subsequent comparison by the user.

From a previous example, mid-process reconfiguration program 300 determines a modification is required that includes a reversal of progress to at least the 7^{th} step of the workflow steps of the process stream from the current state of the 9^{th} step of the workflow steps of the process stream, based on the analyzing of the context. Mid-process reconfiguration program 300 reverses to 7^{th} step in the workflow steps for the original process stream and stores any data associated with the completed 7^{th} and 8^{th} workflow steps in the original process stream. From another previous example, mid-process reconfiguration program 300 determines a modification is required that includes a reversal and a discarding of all previously performed workflow steps and re-initialization of a new process stream is required. Mid-process reconfiguration program 300 reverses to 1^{st} step in the workflow steps for the original process stream and deletes all previous progress from the original process stream. From yet another previous example, mid-process reconfiguration program 300 determines a modification is required that includes altering the workflow steps from a future step (i.e., the 7^{th} step) from the workflow steps and implementing a new process stream from the 7^{th} step onwards in the workflow steps. Mid-process reconfiguration program 300 alters the future workflow steps for the process stream that have yet to be performed in the process stream.

Mid-process reconfiguration program 300 resumes the process stream (320). From a previous example, mid-process reconfiguration program 300 performed a modification that included reversing to 7^{th} step in the workflow steps for the original process stream and storing the data associated with the completed 7^{th} and 8^{th} workflow steps in the original process stream. In this example, mid-process reconfiguration program 300 resumes the process stream by initializing a new process stream from the 7^{th} workflow step based on the received request. From another previous example, mid-process reconfiguration program 300 reversed to 1^{st} step in the workflow steps for the original process stream and deleted all previous progress from the original process stream. In this example, mid-process reconfiguration program 300 resumes the process stream by re-initializing a new process stream from the 1^{st} workflow step based on the received request. From yet another previous example, mid-process reconfiguration program 300 altered the future workflow steps for the process stream that have yet to be performed in the process stream. In this example, mid-process reconfiguration program 300 resumes the process stream by initiating a new process stream from the 7^{th} workflow step based on the received request.

FIG. 4A illustrates an example of a mid-process reconfiguration program initiating a process stream, in accordance with an embodiment of the present invention. In this example, mid-process reconfiguration program 300 initiates a process stream by performing each of workflow steps A through F previously established for the process stream. Workflow steps A through F represent a workflow process for an online retailer's order fulfillment system, where a user developed an AI-generated process for purchase and shipping management for the online retailer. Mid-process reconfiguration program 300 initiates the process stream upon receiving an order (i.e., event trigger) for the online retailer, which subsequently resulting the workflow steps of the process being performed across multiple applications.

FIG. 4B illustrates an example of a mid-process reconfiguration program receiving a request during a process stream indicative of reversal of progress, in accordance with an embodiment of the present invention. In this example, during the performing of the workflow steps, mid-process reconfiguration program 300 receives, via the AI chatbot, a request and determines the request is indicative of reversal of process and/or data changes. Mid-process reconfiguration program 300 determines the request includes an alteration to object data pertaining to customer preferences in a workflow step C of the process stream, where workflow step C was already performed in the process stream. Mid-process reconfiguration program 300 analyzes the context for the reversal of the progress and/or data change and determines that a current workflow step of the process stream is currently transitioning to workflow step D in the process stream. Therefore, mid-process reconfiguration program 300 determines a reversal of progress is required to at workflow step C of the process stream based on the analyzing of the context.

FIG. 4C illustrates an example of a mid-process reconfiguration program determining a modification and performing the modification that includes a reversal of progress, in accordance with an embodiment of the present invention. In this example, mid-process reconfiguration program 300 determines a modification is required that includes a reversal of progress of workflow step C of the process stream from the current state of transitions to workflow step D of the process stream, based on the analyzing of the context by mid-process reconfiguration program 300. Mid-process reconfiguration program 300 reverses to workflow step C in the workflow steps for the original process stream and stores any data associated with the completed workflow step C in the original process stream. Mid-process reconfiguration program 300 determines a new workflow step C′ is to be performed to initialize a new process stream based on the received request.

FIG. 4D illustrates an example of a mid-process reconfiguration program resuming a process stream along a new branch subsequent to a reversal of progress of an old branch, in accordance with an embodiment of the present invention. In this example, mid-process reconfiguration program 300 initializes a new process stream from the workflow step C′ based on the received request and continues the new process stream performing workflow steps C′ through F′. Mid-process reconfiguration program 300 continues the new process stream until the completion of workflow step F′ or until mid-process reconfiguration program 300 receives another request that can include a modification to the new process stream.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a request during a process stream;
determining the request is indicative of a reversal of progress of the process stream or indicative of a data change being utilized for the process stream;
analyzing a context for the reversal of progress of the process stream or the data change being utilized for the process stream;
responsive to determining a modification is required to at least one workflow step from a plurality of workflow steps of the process stream based on the analyzing of the context, determining the modification performable on the at least one workflow step from the process stream; and
performing the modification on the at least one workflow step from the process stream.

2. The computer-implemented method of claim 1, further comprising:
initializing the process stream based on a trigger event, where the process stream includes the plurality of workflow steps performable across a plurality of applications.

3. The computer-implemented method of claim 2, wherein performing the modification on the at least one workflow step from the process stream further comprises:
reversing from a current workflow step to a previous workflow step in the process stream, wherein the previous workflow step is the at least one workflow step from the process stream where the modification is required;
storing data associated with the process stream between the current workflow step and the previous workflow step; and
re-initializing a new process stream from the previous workflow step based on the request.

4. The computer-implemented method of claim 2, wherein performing the modification on the at least one workflow step from the process stream further comprises:
reversing from a current workflow step to a first workflow step from the plurality of workflow steps in the process stream based on the data change being utilized for the process stream; and
re-initializing a new process stream from the first workflow step from the plurality of workflow steps based on the request.

5. The computer-implemented method of claim 2, wherein performing the modification on the at least one workflow step from the process stream further comprises:
altering a future workflow step from the plurality of workflow steps in the process stream, wherein the future workflow step is the at least one workflow step from the process stream where the modification is required; and
initializing a new process stream from the future workflow step from the plurality of workflow steps based on the request.

6. The computer-implemented method of claim 1, wherein receiving the request during the process stream is via an AI chatbot component.

7. The computer-implemented method of claim 6, further comprising:
training, the AI chatbot component, via one or more user inputs to reverse or discard one or more workflow steps from the process stream based on the request, wherein the one or more user inputs flag, a start point or a stop point for the at least one workflow step in the process stream, or code script in the process stream.

8. A computer program product comprising:
one or more computer-readable storage media;
program instructions, stored on at least one of the one or more storage media, to receive a request during a process stream;
program instructions, stored on at least one of the one or more storage media, to determine the request is indicative of a reversal of progress of the process stream or indicative of a data change being utilized for the process stream;
program instructions, stored on at least one of the one or more storage media, to analyze a context for the reversal of progress of the process stream or the data change being utilized for the process stream;
program instructions, stored on at least one of the one or more storage media, responsive to determining a modification is required to at least one workflow step from a plurality of workflow steps of the process stream based on the analyzing of the context, to determine the modification performable on the at least one workflow step from the process stream; and
program instructions, stored on at least one of the one or more storage media, to perform the modification on the at least one workflow step from the process stream.

9. The computer program product of claim 8, further comprising:
program instructions, stored on at least one of the one or more storage media, to initialize the process stream based on a trigger event, where the process stream includes the plurality of workflow steps performable across a plurality of applications.

10. The computer program product of claim 9, wherein program instructions, stored on at least one of the one or more storage media, to perform the modification on the at least one workflow step from the process stream further comprises:
program instructions, stored on at least one of the one or more storage media, to reverse from a current workflow step to a previous workflow step in the process stream, wherein the previous workflow step is the at least one workflow step from the process stream where the modification is required;
program instructions, stored on at least one of the one or more storage media, to store data associated with the process stream between the current workflow step and the previous workflow step; and
program instructions, stored on at least one of the one or more storage media, to re-initialize a new process stream from the previous workflow step based on the request.

11. The computer program product of claim 9, wherein program instructions, stored on at least one of the one or more storage media, to perform the modification on the at least one workflow step from the process stream further comprises:
program instructions, stored on at least one of the one or more storage media, to reverse from a current workflow step to a first workflow step from the plurality of workflow steps in the process stream based on the data change being utilized for the process stream; and
program instructions, stored on at least one of the one or more storage media, to re-initialize a new process stream from the first workflow step from the plurality of workflow steps based on the request.

12. The computer program product of claim 9, wherein program instructions, stored on at least one of the one or more storage media, to perform the modification on the at least one workflow step from the process stream further comprises:
program instructions, stored on at least one of the one or more storage media, to alter a future workflow step from the plurality of workflow steps in the process stream, wherein the future workflow step is the at least one workflow step from the process stream where the modification is required; and
program instructions, stored on at least one of the one or more storage media, to initialize new process stream from the future workflow step from the plurality of workflow steps based on the request.

13. The computer program product of claim 8, wherein program instructions, stored on at least one of the one or more storage media, to receive the request during the process stream is via an AI chatbot component.

14. The computer program product of claim 13, further comprising:
program instructions, stored on at least one of the one or more storage media, to train, the AI chatbot component, via one or more user inputs to reverse or discard one or more workflow steps from the process stream based on the request, wherein the one or more user inputs flag, a start point or a stop point for the at least one workflow step in the process stream, or code script in the process stream.

15. A computer system comprising:
one or more processors, one or more computer-readable memories and one or more computer-readable storage media;
program instructions, stored on at least one of the one or more storage media for execution by at least one of the one or more processors via at least one of the one or more memories, to receive a request during a process stream;
program instructions, stored on at least one of the one or more storage media for execution by at least one of the one or more processors via at least one of the one or more memories, to determine the request is indicative of a reversal of progress of the process stream or indicative of a data change being utilized for the process stream;
program instructions, stored on at least one of the one or more storage media for execution by at least one of the one or more processors via at least one of the one or more memories, to analyze a context for the reversal of progress of the process stream or the data change being utilized for the process stream;
program instructions, stored on at least one of the one or more storage media for execution by at least one of the one or more processors via at least one of the one or more memories, responsive to determining a modification is required to at least one workflow step from a plurality of workflow steps of the process stream based on the analyzing of the context, to determine the modification performable on the at least one workflow step from the process stream; and
program instructions, stored on at least one of the one or more storage media for execution by at least one of the one or more processors via at least one of the one or more memories, to perform the modification on the at least one workflow step from the process stream.

16. The computer system of claim 15, further comprising:
program instructions, stored on at least one of the one or more storage media for execution by at least one of the one or more processors via at least one of the one or more memories, to initialize the process stream based on a trigger event, where the process stream includes the plurality of workflow steps performable across a plurality of applications.

17. The computer system of claim 16, wherein program instructions, stored on at least one of the one or more storage media for execution by at least one of the one or more processors via at least one of the one or more memories, to perform the modification on the at least one workflow step from the process stream further comprises:
program instructions, stored on at least one of the one or more storage media for execution by at least one of the one or more processors via at least one of the one or more memories, to reverse from a current workflow step to a previous workflow step in the process stream, wherein the previous workflow step is the at least one workflow step from the process stream where the modification is required;
program instructions, stored on at least one of the one or more storage media for execution by at least one of the one or more processors via at least one of the one or more memories, to store data associated with the process stream between the current workflow step and the previous workflow step; and
program instructions, stored on at least one of the one or more storage media for execution by at least one of the one or more processors via at least one of the one or more memories, to re-initialize a new process stream from the previous workflow step based on the request.

18. The computer system of claim 16, wherein program instructions, stored on at least one of the one or more storage media for execution by at least one of the one or more processors via at least one of the one or more memories, to perform the modification on the at least one workflow step from the process stream further comprises:
program instructions, stored on at least one of the one or more storage media for execution by at least one of the one or more processors via at least one of the one or more memories, to reverse from a current workflow step to a first workflow step from the plurality of workflow steps in the process stream based on the data change being utilized for the process stream; and
program instructions, stored on at least one of the one or more storage media for execution by at least one of the one or more processors via at least one of the one or more memories, to re-initialize a new process stream from the first workflow step from the plurality of workflow steps based on the request.

19. The computer system of claim 16, wherein program instructions, stored on at least one of the one or more storage media for execution by at least one of the one or more processors via at least one of the one or more memories, to perform the modification on the at least one workflow step from the process stream further comprises:
program instructions, stored on at least one of the one or more storage media for execution by at least one of the one or more processors via at least one of the one or more memories, to alter a future workflow step from the plurality of workflow steps in the process stream, wherein the future workflow step is the at least one workflow step from the process stream where the modification is required; and
program instructions, stored on at least one of the one or more storage media for execution by at least one of the one or more processors via at least one of the one or more memories, to initialize new process stream from the future workflow step from the plurality of workflow steps based on the request.

20. The computer system of claim 15, further comprising:
program instructions, stored on at least one of the one or more storage media, to train, the AI chatbot component to receive the request, via one or more user inputs to reverse or discard one or more workflow steps from the process stream based on the request, wherein the one or more user inputs flag, a start point or a stop point for the at least one workflow step in the process stream, or code script in the process stream.
